(19) United States
(12) Patent Application Publication
(10) Pub. No.: US 2015/0221903 A1
(43) Pub. Date: Aug. 6, 2015

(54) INSERT FOR COVERING A MOTOR VEHICLE BATTERY

(71) Applicant: GM GLOBAL TECHNOLOGY OPERATIONS LLC, Detroit, MI (US)

(72) Inventors: Stefan Lummitsch, Ginsheim (DE); Wolfgang Back, Ruesselsheim (DE); Fabian De Luca, Luedenscheid (DE)

(21) Appl. No.: 14/610,947

(22) Filed: Jan. 30, 2015

(30) Foreign Application Priority Data
Feb. 1, 2014 (DE) 102014001351.0

(51) Int. Cl. H01M 2/10

(52) U.S. Cl. CPC H01M 2/10

(57) ABSTRACT

An insert for covering a battery is disclosed in which the insert is arranged below a load surface in a motor vehicle. In installation position in the motor vehicle, the insert has a flat carrier surface on its top side for a load surface cover to be arranged thereon. The insert on its bottom side facing away from the top side has at least one integrated air duct structure.

### CROSS-REFERENCE TO RELATED APPLICATION

This application claims priority to German Patent Application No. 10 2014 001 351.0, filed Feb. 1, 2014, which is incorporated herein by reference in its entirety.

### TECHNICAL FIELD

The present disclosure relates to an insert for covering a battery arranged in a motor vehicle below a load surface, which insert in an installation position in the motor vehicle includes a flat carrier surface on its top for a load surface cover to be arranged thereon.

### BACKGROUND

Alternative drive systems, in particular electric or hybrid drives require that one or multiple rechargeable batteries are carried along in the motor vehicle. For as low as possible a center of gravity position of the motor vehicle, arranging batteries in the region of a floor structure, in particular on a floor panel or on comparable supporting structural components of the motor vehicle body proves to be practical.

The waste heat which develops in the region of the battery during the operation of the motor vehicle however has to be discharged to the environment by means of cooling specifically provided for this purpose.

To discharge the thermal energy liberated in the region of a battery mounting located approximately in the middle in vehicle transverse direction (y) the battery mounting that is covered by the load surface towards the top is typically coupled to a separate air duct which with one end, in the present case a front end, is fluidly connected to the battery mounting and the other end of which is led through an interior trim of the motor vehicle in vehicle transverse direction (y) or approximately at the rear end in vehicle longitudinal direction (x).

To realize such air discharge a separate mounting of a suitable air duct therefore has to be provided. An air duct running above a floor panel can typically be covered by means of an insert spanning the entire load surface, which insert provides a mechanical support function for a cover lying on top of the same. During the mounting of an insert strict attention must be paid on ensuring that the same is arranged on the floor panel without colliding with the air duct. This requires high dimensional accuracy for the arrangement and for the installing of the air duct along a predetermined path. In addition to this, the air duct can only make available a limited flow cross section so that because of structural restrictions in the region below the load surface a flow resistance that is substantially predetermined by the flow cross section and by the course of the air duct cannot be further reduced.

### SUMMARY

In accordance with the present disclosure an air outlet that is improved with respect to flow for a battery mounting to be arranged typically at the rear end and below a load surface is provided. The air discharge is to be realizable preferentially subject to reducing the number of components and also subject to reducing the vehicle weight. In addition, the improved air discharge is to make possible particularly simple mounting during the production process of the motor vehicle. In addition, other objects, desirable features and characteristics will become apparent from the subsequent summary and detailed description, and the appended claims, taken in conjunction with the accompanying drawings and this background.

Accordingly, an insert is provided for covering a battery arranged in a motor vehicle below a load surface. The insert in installation position in the motor vehicle has a flat carrier surface on its top for a load surface cover to be arranged thereon. The insert furthermore includes at least one integrated air duct structure on a bottom side facing away from the top side. Upon installation of the insert in the motor vehicle as intended, the duct structure in this case replaces a conventional air duct to be separately mounted in the motor vehicle, which runs approximately between the battery mounting and an interior trim.

By providing an integrated air duct structure on or in the bottom side of the insert, the use of a separate air duct can be advantageously omitted. This produces not only a simplified assembly but the weight of a previously provided air duct can also be saved. In addition, the number of components to be provided by the air discharge is advantageously reduced by integrating the duct structure in the insert. For forming an air discharge for the battery mounting it is henceforth merely necessary to arrange an insert provided with integrated air duct structure as intended in the region of the battery mounting.

The insert, which typically projects in vehicle longitudinal direction (x) and/or in vehicle transverse direction (y) as far as to at least one lateral or rear-end interior trim can, in addition to its supporting function for a load surface cover provide air ducting at the same time and directly in particular for discharging cooling air heated in the region of the battery mounting and supplied otherwise or equally by way of the insert of the battery mounting.

The air duct structure integrated in the bottom side of the insert can be equally provided for the air supply for the battery mounting and also for the air discharge of heated cooling air out of the region of the battery mounting and be used accordingly. Originally, the insert serves as height-compensating filler section, which has a flat carrier surface and with its bottom side can be placed on the top side of a floor panel facing the vehicle interior. On its bottom side, the insert has a contour corresponding to the floor panel so that any irregularities resulting from the carcass of the body can be offset and a substantially flat and large-area carrier surface for a load surface cover, thus for a loading platform, can be provided.

By the insert having at least one integrated air duct structure on its bottom side facing the floor panel the insert in addition to its mechanical and supporting function is simultaneously assigned also an air-conducting function for supplying a battery mounting with cooling air fed from the interior of the motor vehicle.

According to a further development, a blower compartment for receiving a blower, typically a suction blower is formed on the bottom side of the insert. The blower compartment can be designed in the manner of a pocket-shaped depression on the bottom side of the insert. Here, the blower compartment typically includes a geometry corresponding to the suction blower to be arranged therein. By providing a blower compartment in or on the bottom side of the insert, a blower which can be approximately fitted accurately into the blower compartment can be fixed in the plane parallel to the carrier surface of the insert on the insert itself.

According to a further configuration, the suction blower can be fastened and preassembled to the bottom side of the insert. In this way, the insert can as it were provide a blower module with a suction blower arranged thereon in a preassembled manner, which, preconfigured accordingly, can be installed in the motor vehicle with a suction blower preassembled in the blower compartment. Separate mounting of a suction blower for example to the floor structure of the motor vehicle on the body side can thus be advantageously omitted. This leads to a reduced assembly and production effort.

According to a further configuration, the duct structure formed on the bottom side of the insert opens into the blower compartment with one end. By directly coupling the duct structure in or to the blower compartment, a suction or pressure effect can be exerted on the duct structure by means of the blower arranged in the blower compartment. Accordingly, by being directly connected to the blower compartment the duct structure can be supplied with a suction air or pressure air flow and thus serve for supplying air or discharging air directly and preferably without loss of pressure.

According to a further configuration, the insert includes a battery compartment designed for receiving or enclosing the battery. The battery compartment can either be configured similar to the blower compartment as a pocket-like depression on the bottom side of the insert. However, the battery compartment can also be configured open or opened towards the bottom and in this regard constitute a passage opening or a break-through in the carrier surface of the insert. By opening with one end into the battery compartment, the duct structure can either act as air supply for the battery compartment or as air discharge for discharging cooling air heated in the region of the battery compartment.

Here it is conceivable in particular that at least two duct structures which are spaced and thus separate from one another and can merely be fluidly connected to one another via the battery compartment and/or the blower compartment are formed in the bottom side of the insert, wherein one duct structure opens as air inlet into the battery compartment and wherein one other duct structure opens as air outlet into the blower compartment. Here it can be provided in addition that the blower compartment is directly fluidly connected with the battery compartment with a section facing away from the duct structure. Equally or as a further development it is obviously also conceivable that a duct structure of the bottom side of the insert acts as an air duct between blower compartment and battery compartment and fluidly interconnecting those depressions or passages in the bottom side of the insert provided in each case for the battery and for the blower.

In this way, the insert can form a suction line and a pressure line for drawing in and discharging cooling air with the suction blower arranged for example thereon in a preassembled manner, so that both for the air supply and also for the air discharge providing and mounting separate air ducts can be omitted.

According to a further configuration, the insert includes a side wall in which at least one outlet or one inlet is provided. Another end of the duct structure in this case opens into at least one of outlet and inlet. For example it can be provided that a duct structure extends from an inlet to the battery compartment while the other duct structure extends from the blower compartment to the outlet. By integrating at least one outlet or inlet in the side wall of the insert a lateral connection for air supply or air discharge can be provided and directly integrated in the insert.

According to a further configuration, at least one of inlet and outlet includes a connector which projects or is set back with respect to the adjoining side wall. The design of set-back or projecting connector can be advantageous in particular for the lateral and air-conducting connection of the duct structure to adjoining motor vehicle components, in particular to an interior trim. When the insert on reaching its final installation position in the motor vehicle is situated approximately adjoining an interior trim with its side wall, a connection on the inlet side or outlet side that is particularly easy to realize of the at least one air duct structure of the insert to further air-conducting components can be provided by means of projecting or set-back connectors and connecting geometries in the region of the interior trim corresponding thereto. According to a further configuration, the duct structure of the insert formed on the bottom side is designed open towards the bottom or opened towards the bottom. In cross section, the duct structure can for example have a U or V-shaped cross sectional contour which is opened towards the bottom. By arranging the insert on a floor panel of the motor vehicle, the air duct structure of the insert interacting with the floor panel can form an air-conducting inlet or outlet duct that is closed in cross section.

On assuming the final installation position on the motor vehicle, the at least one air duct structure integrated in the insert can be closed off by the floor panel for forming an air-conducting inlet or outlet duct. Forming a duct structure in the insert that is open or opened towards the bottom proves to be particularly advantageous in terms of assembly. Thus, the insert can be configured largely free of undercuts and accordingly be produced with comparatively simple forming tools.

According to a further configuration, at least one seal is arranged on a boundary edge of the duct structure projecting downwards. Here it can be provided in particular that all boundary edges of the duct structure are continuously provided with a seal so that upon arrangement of the insert on the floor panel the duct structure can be closed off by the floor panel for forming the outlet or inlet duct preferably completely and in an air-tight manner. Soft-elastic sealing materials such as for example sealing lips on elastomer basis but also sealing compounds that can be manually applied on the boundary edge of the duct structure only immediately prior to the final assembly are possible as seal, which for example expand or respectively swell up and/or cure after or during the assembly in order to provide a permanent seal between the duct structure and the floor panel.

According to a further configuration, the insert includes a one-piece molded body, a foamed body or a pressure-resistant body formed of a particle foam material. The molded body, as well as the foamed body in this case is configured in an equally pressure-resistant manner in order to distribute for example the mechanical loads acting via the carrier surface provided on the top side over the carrier surface and to discharge these into the floor panel. The insert can be produced for example from a shaped plastic part or from a plastic injection molded part. It is conceivable, furthermore, that the molded part is formed of an expanded particle foam material, for example on polypropylene basis. The particle foam material in this case is introduced into suitable molds and then typically by means of introducing steam brought to expand against the inner surfaces of the mold. Thus, the insert can be configured in particular as an EPP molded part (expanded polypropylene).

According to a further aspect, a motor vehicle with an interior, in particular a passenger car, is finally provided, which in the region of a floor panel below a load surface, typically in the region of a rear-end load surface includes a battery mounting for mounting a battery, typically a rechargeable battery. The motor vehicle is provided furthermore with an insert described before, which is arranged on the floor panel in the intended manner and if appropriate also connected to the floor panel or to further motor vehicle components such as for example an interior trim.

By inserting the insert in an assembly position in or on the motor vehicle provided for this purpose and by concomitant arranging of the insert on the floor panel, the air duct structures can be closed off on the bottom side of the insert from the floor panel for forming air-conducting inlet or outlet ducts. By installing the insert in the motor vehicle, an air supply and/or discharge for a battery arranged below the load surface can be realized without further or separate assembly steps.

According to a further development thereof, at least one end of at least one air duct structure integrated into the insert is fluidly connected to the battery mounting of the insert. The battery mounting can be typically integrated in the floor panel and for example be configured as depression in the floor panel or as recess in the floor panel, wherein a separate battery mounting can be arranged in a mounting on the floor panel side. The air duct structure is geometrically formed on the bottom side of the insert in such a manner that with the insert installed in the motor vehicle as intended it forms an air-conducting inlet or outlet duct for the battery mounting. In this way, the function of a conventional air duct to be separately provided below the load surface can be advantageously omitted.

According to a further configuration, a side wall of the insert borders on an interior trim of the motor vehicle in vehicle transverse direction as soon as the insert has assumed its final installation position or final assembly position in the motor vehicle. Typically, the contour of the side wall of the insert is adapted to a contour of the interior trim corresponding thereto, so that a mutual contact position over as full an area or large an area as possible of insert and interior trim is obtained.

An accurately fitting configuration of the side wall to the interior trim makes possible an accurately fitting assembly and also fixing of the insert between interior trim sections located opposite in vehicle transverse direction. In addition, by way of a directly adjoining arrangement of the side wall of the insert on an inside, i.e. a side of the interior trim facing the vehicle middle air-conducting coupling between an inlet on the insert side and/or outlet and air-conducting structures or break-through of the interior trim corresponding thereto can be provided.

As a further development thereof, at least one outlet or inlet of the insert provided in the side wall and fluidly connected to the duct structure is arranged aligned with at least one passage opening of the interior trim. The flow cross section of outlet or inlet of the insert, on reaching the final installation position of the insert in the motor vehicle, is arranged at least partially overlapping a passage opening of the interior trim. An air supply or an air discharge can in this regard be routed through the interior trim to the inside or to the outside in order to supply the insert, which in the final installation position is typically arranged behind a backrest and below a load surface and/or in order to discharge heated cooling air to the outside.

Providing at least one outlet or inlet in the region of the side wall of the insert proves to be particularly advantageous for a flow-related coupling of a passage opening of an interior trim located opposite on the motor vehicle side. In this way, an air-conducting structure can be rendered through the interior trim and directly into the air duct structure or into the inlet or outlet duct of the insert.

According to a further configuration, the interior trim of the motor vehicle forms a hollow space or air supply or air discharge through which cooling air can flow with a body side wall that is spaced from said interior trim at least in regions. Here, the hollow space can quasi act as air duct and in particular via the at least one passage opening in the interior trim be fluidly connected in terms of flow to the inlet or outlet ducts formed by air-conducting structure of the insert and the floor panel.

Here it is conceivable in particular that the hollow space formed between interior trim and body side wall is also subdivided in vehicle longitudinal direction into a front hollow space and into a rear hollow space, wherein each of the two hollow spaces is fluidly coupled separately via at least one passage opening in the interior trim each to an inlet channel and to an outlet channel, both of which channels are formed by the air duct structure integrated in the insert and the floor panel located below.

### BRIEF DESCRIPTION OF THE FIGURES

The present disclosure will hereinafter be described in conjunction with the following drawing figures, wherein like numerals denote like elements.

FIG. 1 a schematic top view of the rear region of a motor vehicle with a battery mounting arranged below a load surface;

FIG. 2 a cross section in vehicle vertical direction (z) and vehicle longitudinal direction (x) through the rear region of the motor vehicle along the section line A-A according to FIG. 1;

FIG. 3 an isolated perspective representation of the insert viewed obliquely from above;

FIG. 4 a perspective representation of the insert according to FIG. 3 viewed obliquely from below;

FIG. 5 an isolated and perspective representation of the interior trim viewed obliquely from the front and inside;

FIG. 6 a perspective and isolated representation of the interior trim according to FIG. 5 viewed obliquely from the outside and the back; and

FIG. 7 a schematic lateral view of a motor vehicle.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

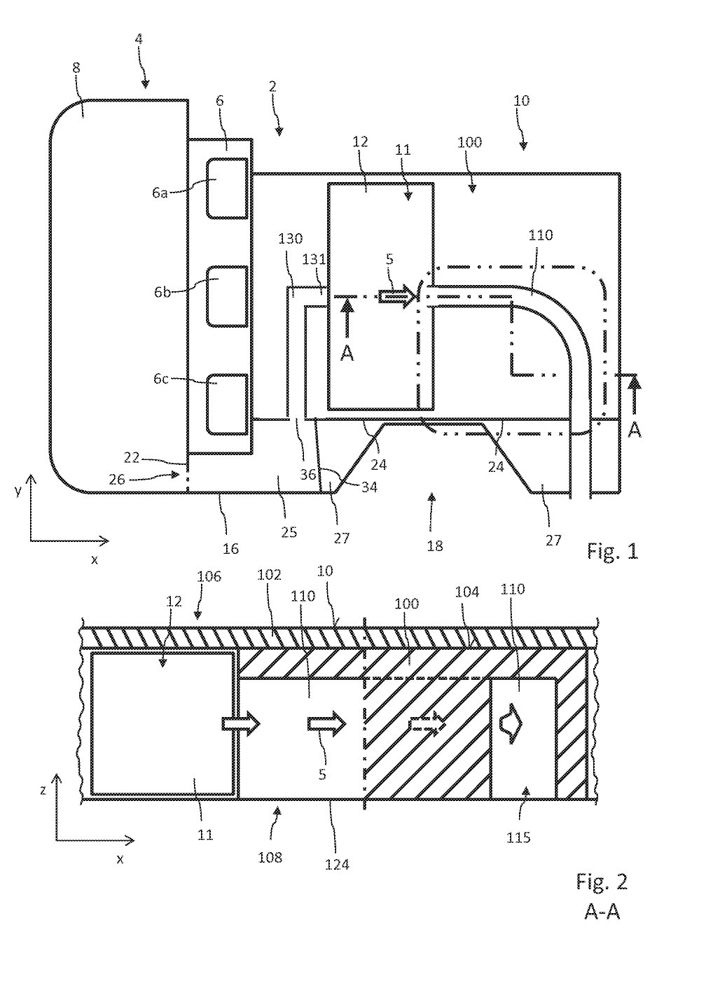

FIG. 1 shows an air discharge 140 for a battery mounting 12 on the example of a battery 11 that can be arranged below a load surface 10 on the rear end in a simplified top view. The motor vehicle interior 2 includes a rear seat bench 8 substantially extending over the entire vehicle width and a backrest 6 adjoining thereon against the travelling direction of the motor vehicle, i.e. in vehicle longitudinal direction (x) with headrest 6a, 6b, 6c arranged thereon and in each case spaced in vehicle transverse direction (y). Interior trim 14, which is arranged spaced from a body side wall 16 in vehicle transverse direction (y) extends laterally and behind the backrest 6. In the region of the body side wall 16, a wheelhouse 18 projecting to the inside for example for a left rear wheel is additionally suggested. The region of the motor vehicle located behind the backrest 6 serves as loading zone and has a load surface 10 which is substantially configured flat.

As is shown in FIG. 1 on the example of the left vehicle side, a hollow space is located between the interior trim 24 and a body side wall 16 which is spaced in this respect in vehicle transverse direction (y), which is subdivided into a front hollow space 25 and into a rear hollow space 27 by means of a separating wall 24.

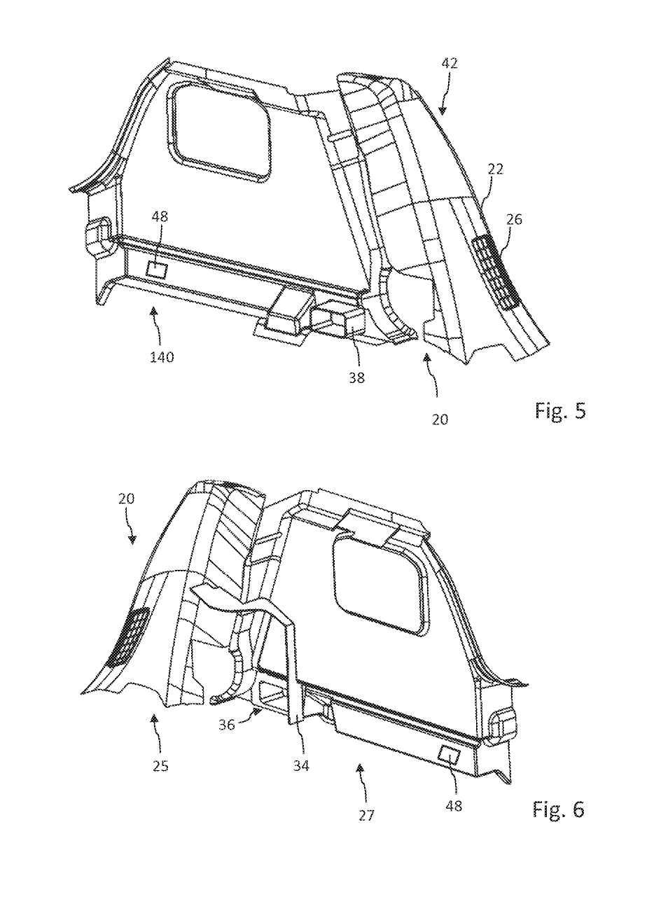

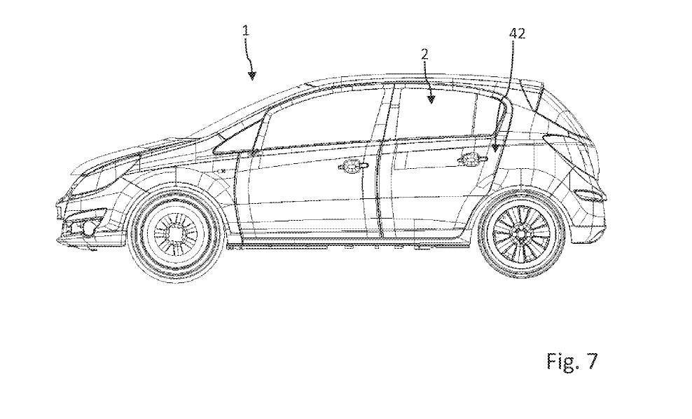

Towards the front, i.e. in travelling direction, the front hollow space 25 is bounded by an inlet surface 22 of the interior trim 24. In the region of the inlet surface 22, as the same is also shown for example in an outside view in FIG. 5 in perspective representation, multiple inlet openings 26 are formed via which the front hollow space 25 is fluidly connected to the interior 2 of the motor vehicle, thus to the passenger cell. Typically, the inlet surface 22 is provided with a grille insert in the region of the inlet openings 26, which includes multiple air inlet slits for the cooling air 5 to be supplied to the hollow space 25. However it is also conceivable that the inlet openings 26 or such a grille structure or a perforated structure are unitarily formed with the interior trim and in a manner of speaking is or are integrated in the inlet surface 22.

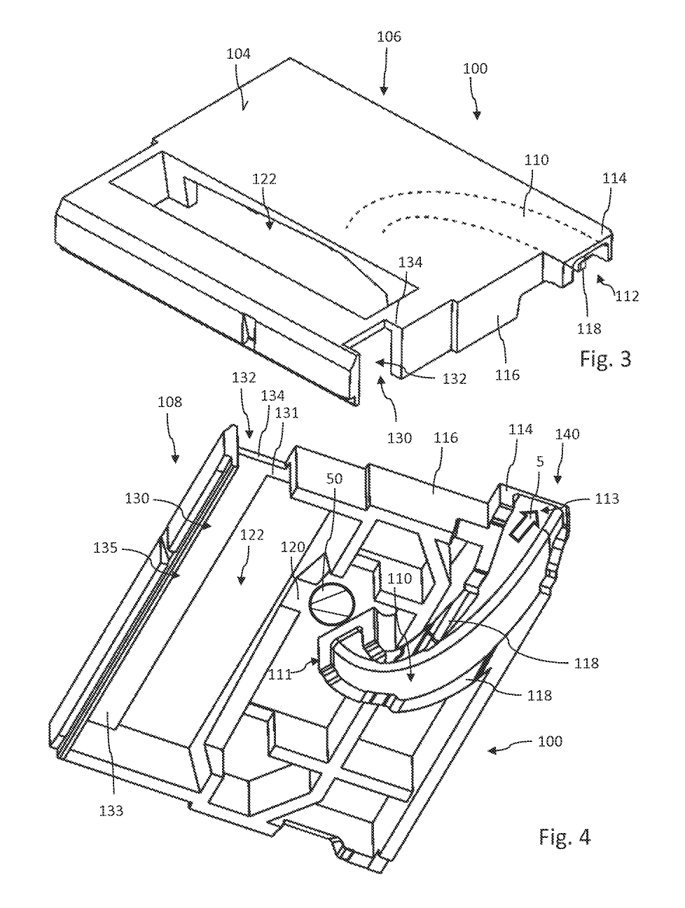

In the region of the front hollow space 25, as shown in detail in FIG. 6, a passage opening 36 is provided in the interior trim 24, which with respect to the vehicle vertical direction (z) is located below a load surface 10 and accordingly in the region of an insert 100, which in FIGS. 3 and 4 is shown isolated and in various perspective views. By means of the front hollow space 25 and the passage opening 36 on the interior trim, a particularly simple and cost-effective air supply 20 can be realized. A region of the interior trim 24 located in travelling direction at the front can, as rudimentarily shown in FIG. 5, can function as C-pillar trim 42 and in this regard cover the body side wall 16 in a corresponding C-pillar section as well as in a region following thereon in vehicle longitudinal direction against the traveling direction subject to forming the front and also the rear hollow space 25, 27.

The unitarily configured insert 100 includes on its top side 106 a carrier surface which is substantially configured flat. The carrier surface 104 serves for supporting a load surface cover 102, consequently a loading platform. Towards the bottom in vehicle vertical direction (z) the insert 100 is supported by a floor panel 124 sketched in FIG. 2. The insert 100 in particular serves as spacer or filler for an installation space or dead volume extending between the load surface 10 and the floor panel 124 on the body side.

As shown in FIG. 4 and as is evident furthermore from viewing FIGS. 1 and 2 together, the insert 100 serves as an air duct structure 110 acting as air discharge 140, which is substantially integrated in the bottom side 108 of the insert 100. The air duct structure 110 is designed in cross section substantially U-profile like or V-like with a geometry that is open towards the bottom so that on reaching a final installation position on a floor panel 124 on the body side the air duct structure 110 can be closed off by the floor panel 124 for forming an outlet duct. For forming an outlet channel that is sealed with respect to the surroundings, the boundary edges of the duct structure 110 facing the floor panel 124 are provided with a seal 118, as is at least suggested in FIG. 4.

The outlet duct formed by the air duct structure 110 opens into an outlet 112 on a side wall 116 of the insert 100 as shown in FIG. 3. Here, the outlet 112 includes a connector 114 projecting from the bordering side wall 116 towards the outside for connection to an air-conducting structure extending the outlet duct 115 approximately in the form of a passage opening 48 suggested in FIG. 5.

A corresponding end 113 of the duct structure 110 on the outlet side or of the outlet duct 115 formed by the duct structure 110 and the floor panel 124 thus opens into an outlet 112 on the side wall side. An opposite end 111 of the outlet duct 115 by contrast opens into a blower compartment 120, in which a blower 50 which in FIG. 4 is merely suggested is arranged. In terms of flow, the blower 50 can be coupled directly to a battery compartment 122 of the insert 100 located opposite the end 111 of the outlet duct 115 on the inlet side. As is shown in particular in FIG. 3, the battery compartment 122 can be configured as break-through in the carrier surface 104. In final assembly configuration, the battery 11 is typically arranged aligned with and in a sealing manner relative to the carrier surface 104, so that the cover 102 can be placed preferably flat over the battery 11 as well as onto the carrier surface 104 of the insert.

In the final installation position the battery 11 comes to lie in the batter compartment 122 of the insert. Here, the battery 11 terminates in particular in a sealing manner with the opening rim of the battery compartment 122 located in the carrier surface 104 so that the battery compartment 122 is sealed off upwards towards the cover 102.

In addition to the outlet duct 115, the insert 100 furthermore includes an inlet duct 135, which directly opens into the battery compartment 122. In this regard, the battery compartment 122 merges directly into a further duct structure 130 on the inlet side, which is fluidly connected to an inlet 132 in the side wall 116 of the insert 100. The one end 133 of the duct structure 130 quasi opens into an inlet 132 feeding in cooling air 5, which in this case is formed as a set-back connector 134 in the side wall 116 of the insert 100. An opposite end 131 of that duct structure 130 opens into the battery compartment 122 or into the battery mounting 12 located below.

The insert 100 is formed in particular as a one-piece molded body; in particular as a molded body of expanded polypropylene (EPP), which can be produced particularly cost-effectively, production-rationally and with low own weight. Any air-conducting structures for the air cooling of the battery 12 arranged in the region of the insert 100 and below the load surface 10 can be completely integrated in the insert 100. The configuration of the inlet 132 for an inlet duct 135 as well as the arrangement of an outlet 112 of an outlet duct 115 in or on the side wall 116 of the insert 100 substantially running in vehicle longitudinal direction (x) is particularly advantageous for air supply and air discharged on the other side of an interior trim 24 adjoining thereon.

In a lower and front region of the interior trim 24 which in installation position comes to lie behind the backrest 6 an outlet socket projecting towards the inside can be provided for example, on which the insert 132 of the duct structure 130 of the insert 100 which is open towards the bottom can be fitted during the assembly. In the same manner, a socket corresponding to the outlet 112 which however is not explicitly shown in FIG. 5 can also be provided in a rear lower region of the interior trim 24. Air-conducting socket connections communicating with one another in the transition region between insert 100 and interior trim 24 create a direct air-conducting connection between air-conducting structures of the interior trim 24 and air duct structures 110, 130 of the insert.

As is at least rudimentarily shown in FIGS. 5 and 6, the interior trim 24 includes a passage opening 36 at the height of the inlet duct 35 and a further passage opening 48 at the height of the outlet channel 115, via which the cooling air 5 led away from the battery 12 via the air discharge 114 can be typically discharged to the vehicle surroundings via so-called pressure relief valves. The pressure relief valves can for example be arranged in the rear region of the motor vehicle. In that the passage opening that can be fluidly connected to the outlet duct 115 opens into the rear hollow space 27, which from the front hollow space 25 on the suction side is separated by a separating wall 34, mixing-through of the cooling air 5 of the heating cooling air 5 led away via the outlet duct 115 with comparatively cold cooling air fed to the inlet duct 135 from the interior 2 and via the front hollow space 25 can be avoided.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. An insert for covering a battery arranged in a motor vehicle below a load surface, the insert comprising a top side having a flat carrier surface for a load surface cover to be arranged thereon when arranged in an installation position in the motor vehicle and a bottom side facing away from the top side including at least one air duct structure integrally formed therein.

17. The insert according to claim 16, further comprising an integrated blower compartment for receiving a blower is formed on the bottom side.

18. The insert according to claim 17, wherein the blower is configured to be preassembled and fastened on the bottom side.

19. The insert according to claim 18, wherein the air duct structure comprises a first end opening into the blower compartment.

20. The insert according to claim 19, further comprising a side wall with at least one of an inlet and an outlet, wherein a second end of the air duct structure opens into at least one of the inlet and the outlet.

21. The insert according to claim 20, wherein at least one of the inlet and the outlet comprises a connector offset relative to the side wall.

22. The insert according to claim 16, wherein the duct structure comprises a first end opening into a battery compartment formed to receive a battery.

23. The insert according to claim 21, further comprising a side wall with at least one of an inlet and an outlet, wherein a second end of the air duct structure opens into at least one of the inlet and the outlet.

24. The insert according to claim 23, wherein at least one of inlet and outlet comprises a connector that is offset relative to the side wall.

25. The insert according to claim 16, wherein the air duct structure formed on the bottom side is opened towards the bottom, wherein arranging the insert on a floor panel of the motor vehicle the bottom side can be closed off for forming an air-conducting inlet duct or outlet duct.

26. The insert according to claim 16, further comprising a seal arranged on a boundary edge of the duct structure projecting downwards.

27. The insert according to claim 16, wherein the insert comprises a body selected from the group comprising a one-piece molded body, a foamed body or a pressure-resistant body formed of a particle foam material.

28. A motor vehicle comprising:
an interior region with a battery mounting arranged below a load surface in the region of a floor panel for receiving a battery; and
an insert arranged on the floor panel and including a top side having a flat carrier surface for a load surface cover to be arranged thereon when arranged in an installation position in the motor vehicle and a bottom side facing away from the top side including at least one air duct structure integrally formed therein.

29. The motor vehicle according claim 28, wherein the insert further comprises a side wall adjoining an interior trim in vehicle transverse direction (y).

30. The motor vehicle according to claim 29, further comprising at least one inlet or outlet provided in the side wall and fluidly connected to the duct structure, wherein the at least one inlet or outlet is aligned with at least one passage opening formed in the interior trim.

31. The motor vehicle according to claim 28, wherein the at least one air duct structure of the insert comprises a first end fluidly connected to the battery mounting.

32. The motor vehicle according claim 31, wherein the insert further comprises a side wall adjoining an interior trim in vehicle transverse direction (y).

33. The motor vehicle according to claim 32, further comprising at least one inlet or outlet provided in the side wall and fluidly connected to the duct structure, wherein the at least one inlet or outlet is aligned with at least one passage opening formed in the interior trim.

34. The motor vehicle according to claim 28 wherein the interior trim comprises an outside facing away from the insert and forming a hollow space which defines at least one of an air supply or air discharge defining a cooling air flow path.
